(19) United States
(12) Patent Application Publication
(10) Pub. No.: US 2008/0188223 A1
(43) Pub. Date: Aug. 7, 2008

(54) Method, a system and a network element for performing a handover of a mobile equipment

(75) Inventors: Seppo Vesterinen, Oulunsalo (FI); Mika Kauranen, Espoo (FI); Sami Kekki, Helsinki (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA CORPORATION

(21) Appl. No.: 11/878,459

(22) Filed: Jul. 24, 2007

(30) Foreign Application Priority Data
Feb. 7, 2007 (EP) 07 002 669.5

(51) Int. Cl. H04Q 7/20

(52) U.S. Cl. 455/436

(57) ABSTRACT

A method, a system and a network element for performing a handover of a mobile equipment from a source network to a target network in a mobile telecommunication system, wherein data, which may be transferred via the source network to the mobile equipment when it is linked to the source network, are going to be buffered in a network element in case a need for a handover arises, and the data buffered in the network element are forwarded from the network element to the target network for transferring them to the mobile equipment after it has been linked to the target network.

### FIELD OF THE INVENTION

The present invention relates to a method, a system and a network element for performing a handover of a mobile equipment from a source network to a target network in a mobile telecommunication system.

In particular, the present invention relates to inter radio access handovers (I-RAT) between 3GPP LTE/SAE (long term evolution/network architecture evolution) and 3GPP (third generation partnership project) 2G/3G (second generation/third generation) networks.

### BACKGROUND OF THE INVENTION

The 3GPP has made a decision that active mode mobility must be supported between 3GPP accesses; i.e. an I-RAT handover from a LTE/SAE network to a 2G/3G network will be needed also when the UE (user equipment) is in the LTE active state during a LTE radio access, and an I-RAT handover from a 2G/3G/I-HSPA (internet high speed packet access) network to a LTE/SAE network is needed also when the UE is in the CELL_DCH (cell dedicated channel) or CELL_FACH (cell forward access channel) state in the 3G network or in the TCH (traffic channel) in the 2G network.

In the LTE/SAE network, the UPE (user plane entity) node provides an access gateway function from the evolved packet core to the BS (base stations) or eNB (evolved Node B) in the evolved UTRAN (UMTS (universal mobile telecommunication system) terrestrial radio access network). The UPE performs user plane ciphering (or encryption) and IP (internet protocol) header compression functions for user downlink data, and de-ciphering (or decryption) and de-compression for user uplink data correspondingly. These functions are utilized at the PDCP (packet data convergence protocol) protocol layer on a peer-to-peer interface between the UPE and the UE.

In the cases of inter BS/eNB handovers, the UPE can usually be in a role of a user plane anchor point when only the user plane tunnel needs to be switched to a target BS. This is fully transparent to the PDCP functions in the UPE and the UE, so that the PDCP continues working without disturbance.

In case the UE must be moved to a 2G or 3G access, this may happen when the UE is in the LTE active state. This means that the PDCP functions are active in the UPE and user data are ciphered and possibly also header compressed over a S1-u interface (user plane interface between an eNB and an aGW (access gateway) (MME/UPE)). Now in order to minimize the number of lost downlink packets during handover, the user data delivery should be started to the target system so that these can be transmitted immediately after the user plane break when connectivity is established in the target system.

The problem is with the downlink packets that will be delivered to the eNB over S1-u interface and cannot be sent over a radio link anymore, as the UE has detached from the LTE cell. In order not to lose these packets, they should be sent back to the UPE for de-ciphering, de-compressing and thereafter forwarded to the target system.

So, the transport network capacity is consumed unnecessarily, and a delay is caused when sending user data back and forth. In addition, the required user packet re-processing for de-ciphering and de-compressing in the UPE is not desirable.

A similar problem also applies to I-RAT handovers from a 2G network to a LTE/SAE network where the 2G SGSN (serving GPRS (general packet radio system) support node) corresponds to the UPE and the BSS (base station subsystem) corresponds to the eNB. In the 3GPP 2G system, the SNDCP (subnetwork dependent convergence protocol)/LLC (logical link control) protocols reside in the 2G and the RLC (radio link control)/MAC (medium access control) in the BSS correspondingly. Now, the downlink user data forwarding can be applied from the 2G SGSN to the UPE, and the BSS may indicate the last delivered PDU (packet data unit) over a 2G radio interface to the SGSN with a “Start Forwarding” message.

A similar problem at least partially applies to I-RAT handovers from UTRAN to LTE/SAE networks where a RNC (radio network controller) in the UTRAN is connected with “one tunnel” to the 3GPP Anchor. For the HSDPA (high speed downlink packet access) services the PDCP/RLC reside in the RNC and the MAC protocol in the Node B. So, the Node B may indicate the last delivered downlink RLC PDU to the RNC when the radio link is disconnected in order to start downlink user data forwarding correspondingly.

In the 3GPP 3G system, the PDCP, RLC and MAC protocols reside in the RNC. In case the UE must be moved from a 3G network to a LTE/SAE, this may happen when the UE is having a dedicated data connection in the CELL_DCH or in CELL_FACH state. This means that the PDCP, RLC and MAC protocols are active in the 3G system. Now in order to minimize the number of lost downlink packets during the I-RAT handover, the user data delivery should be started to the target system so that these can be transmitted immediately after the user plane break when the connectivity is established in the target system to the UE.

Here again, the problem is with the downlink data packets that will be delivered to the UE over an Iub interface (interface between a RNC and a Node B) and an Air (ad-hoc internet routing protocol) interface cannot be sent anymore, as the UE has detached from the 3G cell. In order not to lose these packets, the RNC should be capable to find out the last PDU that was delivered successfully to the UE and should send undelivered data packets back to 3G SGSN, which then could forward them to the LTE/SAE UPE node. So, the transport network capacity is consumed unnecessarily, and a delay is caused when sending user data back and forth.

A similar problem applies to I-RAT handovers from an I-HSPA system to a LTE/SAE system where the PDCP, RLC and MAC protocols reside in the I-HSPA Node (I-HSPA Node B respectively). In the I-HSPA system, a role of a user plane anchor point resides in operating as a GGSN (gateway GPRS support node). In an I-HSPA system, there do not exist any dedicated controller element in the network. When an I-RAT handover happens, the I-HSPA Node should send user data back to the GGSN which then deliver the data to the LTE/SAE UPE node. This also wastes unnecessarily transport network capacity and causes delays when sending the user data back and forth.

A similar problem also applies to I-RAT handovers from a 2G system to a LTE/SAE system, where the SNDCP and LLC protocols reside in the 2G SGSN and the RLC/MAC in the BSS. In case of inter BSS handovers, the 2G SGSN can usually be in a role of a user plane anchor point when only the user plane tunnel needs to be switched to the target BSS. This is fully transparent to the BSS and to the UE (MS). This means that SNDCP/LLC functions are active in the 2G SGSN, and the user data is ciphered and possibly also header compressed over a Gb interface. Again, the problem is with the downlink packets that will be delivered from the 2G SGSN to the BSC (base station controller) over a Gb interface and cannot be sent over an Abis interface (GSM interface between a base station transceiver system BTS and a base station controller BSC) and a radio interface anymore, as the UE (MS) has detached from the 2G cell. In order not to lose these packets, the BSC should send them back to the 2G SGSN for de-ciphering and decompressing, and thereafter the packets are forwarded to the target system. Also in this case, the transport network capacity is wasted unnecessarily and causes extra delay to send user data packets forth and back. In addition, the required user packet re-processing for de-ciphering and de-compressing in the 2G SGSN is not desirable.

There have been contributions in the 3GPP where alternative implementations are presented for UTRAN to LTE/SAE I-RAT handovers. In all these examples, the user data forwarding is proposed from a UTRAN to a MME(mobility management entity)/UPE. However, it is not dealt with I-RAT handovers between 2G/I-HSPA and LTE/SAE systems.

Another alternative might be to initiate bi-casting during an I-RAT handover preparation phase, i.e. to duplicate user downlink packets from the 3GPP anchor to the target system (=SAE/LTE) and to the source system (either 2G, 3G or HSPA Node).

Also packet duplication could be done in the GERAN (GSM (global system for mobile communications) EDGE (enhanced data rates for GSM evolution) radio access network) at the 2G SGSN, i.e. by sending ciphered and compressed downlink packets over a Gb interface to the BSC and forwarding unmodified user packets (GTP tunnelled IP payload) to the LTE/SAE system at the same time. Respectively, in the UTRAN the 3G SGSN could send downlink packets over an IUps interface (packet switched interface between a RNC and a 3G SGSN) to a RNC and at the same time to a LTE/SAE UPE node. Moreover, in a similar way packet duplication could also be done at the UPE level by sending ciphered and compressed downlink packets to the S1 (interface between an eNB and MME/UPE) and forwarding unmodified S5 (interface between MME/UPE and a 3GPP Anchor) user packets (GTP tunnelled IP payload) to the target system at the same time.

However, in duplicating there is a problem with synchronizing packet delivery, as the target system should receive an indication about the last delivered packet via the source system in order to avoid delivering the packet twice to the UE. Bi-casting also wastes a lot transport capacity which has been identified as being one bottleneck for the system; this becomes a bigger problem, when the data transmission becomes bigger with higher data speeds.

### SUMMARY OF SOME EXEMPLARY EMBODIMENTS

From end user perspective there is a need to have a lossless/seamless handover in order to avoid disturbing breaks in the ongoing service(s) so that the handover performance is sufficient e.g. for continuity in a VoIP (voice over IP) call.

In order to achieve the aforementioned and further objects, in accordance with a first aspect, there is provided a method for performing a handover of a mobile equipment from a source network to a target network in a mobile telecommunication system, wherein data, which may be transferred via the source network to the mobile equipment when it is linked to the source network, are going to be buffered in a network element in case a need for a handover arises, and the data buffered in the network element are forwarded from the network element to the target network for transferring them to the mobile equipment after it has been linked to the target network.

In accordance with a second aspect, there is provided a system for performing a handover of a mobile equipment from a source network to a target network in a mobile telecommunication system, comprising at least a network element including at least a buffer for buffering data, which may be transferred via the source network to the mobile equipment when it is linked to the source network, in case of a need for a handover, and at least an interface connected between the network element and the target network for forwarding the data buffered in the buffer of the network element from the network element to the target network for transferring them to the mobile equipment after it has been linked to the target network.

In accordance with a third aspect, there is provided a network element for performing a handover of a mobile equipment from a source network to a target network in a mobile telecommunication system, comprising at least a buffer for buffering data, which may be transferred via the source network to the mobile equipment when it is linked to the source network, in case of a need for a handover, and at least a transmitter for forwarding the data buffered in the buffer to the target network for transferring them to the mobile equipment after it has been linked to the target network.

According to an embodiment, it is proposed a solution for providing a seamless/lossless I-RAT handover from a LTE system to a 2G or 3G target system without the need to return user PDCP PDUs over SI-u back to the UPE for reprocessing, e.g. by means of the following steps:

1. User downlink data are forwarded from a Source UPE to a Target RNC (3G “one tunnel” solution), or to a Target I-HSPA NodeB, or to the Target 2G SGSN depending on the case.
2. The Source. UPE starts buffering “full” user downlink GTP-U (user plane part of the GTP) packets received over a S5 interface from a 3GPP Anchor by keeping copies of those in a downlink buffer immediately after it has received a “Relocation Required” Indication from the eNB indicating that an I-RAT handover preparation phase has been initiated. The UPE may still continue the PDCP processing of these packets and delivery down to the eNB over S1-u.
3. Upon reception of a “Relocation Acknowledge” from the target system, the MME/UPE incorporates the number of the first buffered downlink into the relocation command that is sent to the eNB. In case the eNB has older undelivered downlink packets in its downlink buffer than the first buffered packet in the UPE, the eNB shall postpone the handover command to the UE in order to deliver the older packets over the radio link. Otherwise these will be lost or should be sent back to the UPE for additional processing over a S1-u interface.
4. The eNB retrieves the S1-u sequence number of the last fully delivered downlink PDCP PDU, when it has detected that the UE has detached from the radio link, and sends an indication of it to the UPE with a “Start Forwarding” message.
5. Upon reception of a “Start Forwarding” message, the UPE stops its UE specific PDCP functions for downlink data and starts forwarding user downlink data to the target system beginning from the indicated last PDU.
6. In addition to the downlink buffered packet(s) the new arrived GTP-U packets from the 3GPP Anchor are forwarded after the buffered packets are delivered first.
7. The Target system (Target RNC/I-HSPA Node B or 2G SGSN) buffers the forwarded user downlink packets until user plane connectivity is available to the UE via a RNC/I-HSPA Node B or BSS. In this way, duplicate packet delivery in the target system can be avoided so that the requirement for seamless/lossless handover is met.
8. The user-plane switching from the 3GPP anchor to the Target RNC/I-HSPA NodeB or 2G SGSN happens in control of a 3G SGSN or 2G SGSN according to the current 3GPP procedures upon reception of a “Relocation/Handover Complete” from the UTRAN or BSS depending on the case.
9. The UPE is capable to continue forwarding user downlink data until the target system indicates it to release UE related resources with a “Forward Relocation Complete” message.
10. In the uplink direction the UE continues sending user PDCP PDUs to the UPE until it has disconnected from the LTE cell/eNB. The uplink/downlink packet delivery continues in the Target System immediately after successful radio handover is executed to the target system according to 3GPP standard procedures.

The following advantages in the I-RAT from LTE/SE to 3GPP 2G/3G systems can be achieved:
Transmission resources can be saved when compared with a bi-casting based solution above the UPE level.
The downlink PDCP PDUs need not to be transmitted from the eNB back to the UPE over a SI-u interface so that transport network capacity can be saved and the additional delay caused by routing user data via the eNB through the last mile links can be avoided.
The loss of older downlink packets stored in the eNB's downlink buffer can be avoided by postponing the radio handover command correspondingly.
The forwarded downlink user data need not to be de-ciphered or decompressed.
An indication of the latest delivered downlink PDCP PDU serves as a “start forwarding command” at the same time.
The UPE is capable to start forwarding from the latest delivered downlink packet in the source system, so that an I-RAT handover can be lossless and duplicate packet delivery can be avoided.
Even if user downlink packets arrive at the Target system in a disorder from the 3GPP Anchor (some packets are forwarded and received directly), it does not harm as an IP stack in the UE can perform a re-ordering at the IP layer and above (IP networks cannot guarantee in-sequence delivery).

According to a further embodiment, it is proposed a solution for providing a seamless/lossless I-RAT handover from a 3G system to a LTE/SAE system without the need to return user data PDUs from a RNC to a 3G SGSN. Respectively, according to another embodiment it is proposed a solution for providing a seamless/lossless I-RAT handover from a I-HSPA system to a LTE/SAE system without the need to return user data PDUs from an I-HSPA Node to a GGSN. According to a still further embodiment, it is also respectively proposed a solution for a seamless/lossless I-RAT handover from a 2G system to a LTE/SAE system without the need to return user data PDUs from a BSC to a 2G-SGSN.

In each of the aforementioned three embodiments, the following steps may be carried out, wherein in each step the feature “A” relates to an I-RAT handover from a 3G system to a LTE/SAE system, the feature “B” relates to an I-RAT handover from a I-HSPA system to a LTE/SAE system, and the feature “C” relates to an I-RAT handover from a 2G system to a LTE/SAE system:
1. A so-called “temporary tunneling” solution is provided wherein
   A) downlink user data are forwarded from a Source RNC to a Target UPE;
   B) downlink user data are forwarded from an I-HSPA Node (=I-HSPA Node B respectively) to a Target UPE;
   C) downlink user data are forwarded from a Source 2G-SGSN to a Target UPE.
2. Data are buffered wherein
   A) the RNC starts buffering “full” user downlink GTP packets received over an IUps interface from a 3G SGSN by keeping copies of those in a downlink buffer immediately after it has received a “Relocation Command” message from a 3G SGSN during an I-RAT handover preparation phase, and the RNC may still continue a PDCP processing of these packets and delivery down to the Node B over an Iub interface;
   B) the I-HSPA Node (1-HSDPA Node B respectively) starts buffering “full” user downlink GTP packets received over an IUps from a GGSN (3GPP Anchor) by keeping copies of those in a downlink buffer immediately after it has sent a “Relocation Required” message to the GGSN, i.e. the I-RAT handover preparation phase has been initiated, and the I-HSPA Node may still continue a PDCP processing of these packets and delivery down to the UE over an Air interface;
   C) the 2G SGSN starts buffering “full” user downlink GTP-U packets received over a Gn interface (interface between a 3G SGSN and a 3GPP Anchor) from a 3GPP Anchor by keeping copies of those in its downlink buffer immediately after it has received a “Handover Required” indication from the BSC, i.e. the I-RAT handover preparation phase has been initiated, and the 2G SGSN may still continue a SNDCP/LLC processing of these packets and delivery down to the BSC over Gb interface.
3. Last delivered PDU is processed wherein
   A) when the UE detaches from a 3G cell, it sends a “L2 (layer 2) ACK (acknowledgement)” for a “Handover Command” message to a RNC, and at the same time it stops its UE specific PDCP functions for downlink data, and lower layers of the RNC keep a track what was the last PDU successfully delivered to the UE based on a sequence number;
   B) when the UE detaches from a 3G cell, it sends a “L2 ACK” for a “Handover Command” message to an I-HSPA Node, and at the same time it stops its UE specific PDCP functions for downlink data, and I-HSPA Nodes lower layers keep a track what was the last PDU successfully delivered to the UE based on a sequence number;
   C) the BSC retrieves a Gb sequence number of the last downlink SNDCP PDU when it has detected that the UE has detached from the radio link, and sends an indication of it to the 2G SGSN with a “Start Forwarding” message.
4. Data forwarding is carried out wherein
   A) when the RNC receives a “L2 ACK” for the “Handover Command” message from a UE, it starts downlink data forwarding to the target system beginning from the first unsent PDU, and in addition to the downlink buffered packet(s) the new arrived GTP packets from the 3G SGSN are forwarded after the buffered packets are delivered first;
   B) when the I-HSPA Node receives a “L2 ACK” for the “Handover Command” message from a UE, it starts downlink data forwarding to the target system beginning from the first unsent PDU, and in addition to the downlink buffered packet(s) the new arrived GTP packets from the GGSN are forwarded after the buffered packets are delivered first;
   C) upon reception of a “Start Forwarding” message the 2G SGSN stops its UE specific SNDCP/LLC functions for downlink data and starts forwarding user downlink data to the target system beginning from the indicated last PDU, and in addition to the downlink buffered packet(s) the new arrived GTP-U packets from a 3GPP Anchor are forwarded after the buffered packets are delivered first.
5. The Target system (UPE/MME) buffers the forwarded user downlink packets until user plane connectivity is available to the UE via an eNB. In this way, duplicate packet delivery in the target system can be avoided, and the requirement for lossless/seamless handover is met.
6. The user-plane switching from a 3GPP anchor to a Target MME/UPE happens, when it receives a “Relocation Complete” message from the eNB.
7. The RNC, I-HSPA Node or 2G SGSN is capable to continue forwarding user downlink data until the target system indicates it to release UE related resources with a “Forward Relocation Complete” message.
8. In the uplink direction, the UE continues sending user PDCP PDUs to the RNC, I-HSPA Node or BSC until it has disconnected from the cell, and the uplink/downlink packet delivery continues in the target system immediately after a successful radio handover is executed to the target system according to 3GPP standard procedures.

The following advantages in the I-RAT from 2G/3G/I-HSPA Node to 3GPP LTE/SAE systems can be achieved:
The downlink PDUs need not to be transmitted forth and back between network elements, transport network capacity can be saved, and the additional delay caused by routing user data between network elements can be avoided, so that
   A) the RNC does not need to deliver data packets back to the 3G SGSN over an IUps interface,
   B) the I-HSPA Node does not need to deliver data packets back to the GGSN over a Gn interface,
   C) the BSC does not need to deliver data packets back to the 2G SGSN over a Gb interface.
The forwarded downlink user data do not need to be de-ciphered or decompressed in case of an I-RAT handover from a 2G system to a LTE system. Indication of the latest delivered downlink PDU serves as a “start forwarding command” at the same time.
The RNC, I-HSPA Node or 2G/3G SGSN is capable to start forwarding from the latest delivered downlink packet in the source system, so that an I-RAT handover can be lossless, and duplicate packet delivery can be avoided.
Even if the user downlink packets arrive at the target system in a disorder from a 3GPP Anchor (some packets are forwarded and received directly), it does not harm, as an IP stack in the UE can make a re-ordering at the IP layer and above (IP networks cannot guarantee in-sequence delivery).
The loss of older downlink packets that are in the RNC's, I-HSPA Node's or BSC's downlink buffer can be avoided by postponing the radio handover command correspondingly.
Transmission resources can be saved when compared with a bi-casting based solution.

Further advantageous embodiments are defined in the dependent claims.

### BRIEF DESCRIPTION OF THE DRAWINGS

The present invention will now be described based on embodiments with reference to the accompanying drawings in which:

FIG. 1 shows a schematic block diagram of a 3GPP access architecture for a LTE/SAE system according to an embodiment;

FIG. 2 shows a schematic block diagram of LTE/SAE protocols according to an embodiment;

FIG. 3 shows a schematic signal flow diagram for a lossless/seamless LTE to UTRAN I-RAT handover according to an embodiment;

FIG. 4 shows a schematic signal flow diagram for a lossless/seamless LTE to GERAN I-RAT handover according to an embodiment;

FIG. 5 shows a schematic signal flow diagram for a lossless/seamless 3G to LTE/SAE I-RAT handover according to an embodiment;

FIG. 6 shows a schematic signal flow diagram for a lossless/seamless I-HSPA Node to LTE/SAE I-RAT handover according to an embodiment; and

FIG. 7 shows a schematic signal flow diagram for a lossless/seamless GERAN to LTE/SAE I-RAT handover according to an embodiment.

### DESCRIPTION OF THE PREFERRED EMBODIMENT

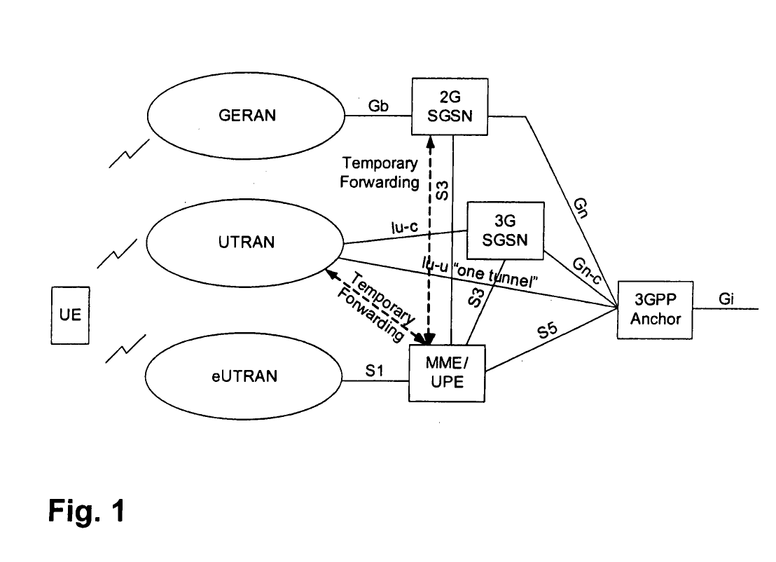

FIG. 1 illustrates a 3GPP (3rd generation partnership project) access architecture in a LTE/SAE (long term evolution/network architecture evolution) system.

As shown, a 3GPP Anchor provides a common user plane anchor for all 3GPP access, i.e. it can be considered to be an evolved GGSN (gateway GPRS (general packet radio network) support node).

A S5 interface (interface between MME/UPE and a 3GPP Anchor) provides control and user plane interfaces to LTE access using a GTP (GPRS tunnelling protocol) protocol.

An Iu-u (user plane interface between a RNC and a MSC or 3G SGSN) in a 3GPP “one tunnel” solution provides a user plane interface for UTRAN (UMTS (universal mobile communication network) terrestrial radio access network) access using a GTP-U (user plane part of a GTP) protocol. The Gn-c interface (control plane interface between a 3G SGSN and a 3GPP Anchor) provides a control plane interface to a 3G SGSN (serving GPRS support node) using a GTP-C (control plane part of a GTP) protocol.

A Gn interface (interface between a 2G SGSN and a 3GPP Anchor) provides control and user plane interfaces to a GERAN (GSM (global system for mobile communications) EDGE (enhanced data rates for GSM evolution) radio access network) access using the GTP protocol.

A S1 interface (interface between an eNB and MME/UPE) between provides a control plane interface between an eNB (evolved Node B) and the MME (mobile management entity) using the evolved RANAP (radio access network application part) protocol and the user plane interface between the eNB and an UPE (user plane entity) using the GTP-U protocol.

A dotted interface from the MME/UPE to the UTRAN terminating in a RNC (radio network controller) or I-HSPA (internet high speed packet access) node with a combined Node B and RNC or from the UTRAN originating in the RNC or the I-HSPA node with a combined Node B and RNC to the MME/UPE is intended for temporary forwarding user downlink data in the I-RAT (inter radio access) handovers using the GTP-U protocol.

A dotted interface from the MME/UPE to the GERAN terminating in the 2G (second generation) SGSN or from the GERAN originating in the 2G SGSN to the MME/UPE is intended for temporary forwarding user downlink data in the I-RAT handovers using the GTP-U protocol

The functional split between the MME, UPE and 3GPP Anchor is open in the 3GPP. It is preferred to specify separated MME and UPE nodes, and keeping the 3GPP Anchor and the UPE usually co-located. However, the UPE relocation is allowed, when the UPE function may move to another node and the 3GPP Anchor remains in the original node. Thus, the S5 interface can also be an external node interface.

The signalling flows are usually provided for co-located MME/UPE, but those could be easily modified for separated MME and UPE, too.

Security related items are open in the 3GPP for user plane data, and it may happen that a UE (user equipment) is sending some ciphering or integrity related indication information inside a Handover Command Acknowledge message via the eNB to the UPE/MME. Based on this information, the UPE/MME could generate encryption for the user data. Because these are open items in the 3GPP, the order of signalling might change.

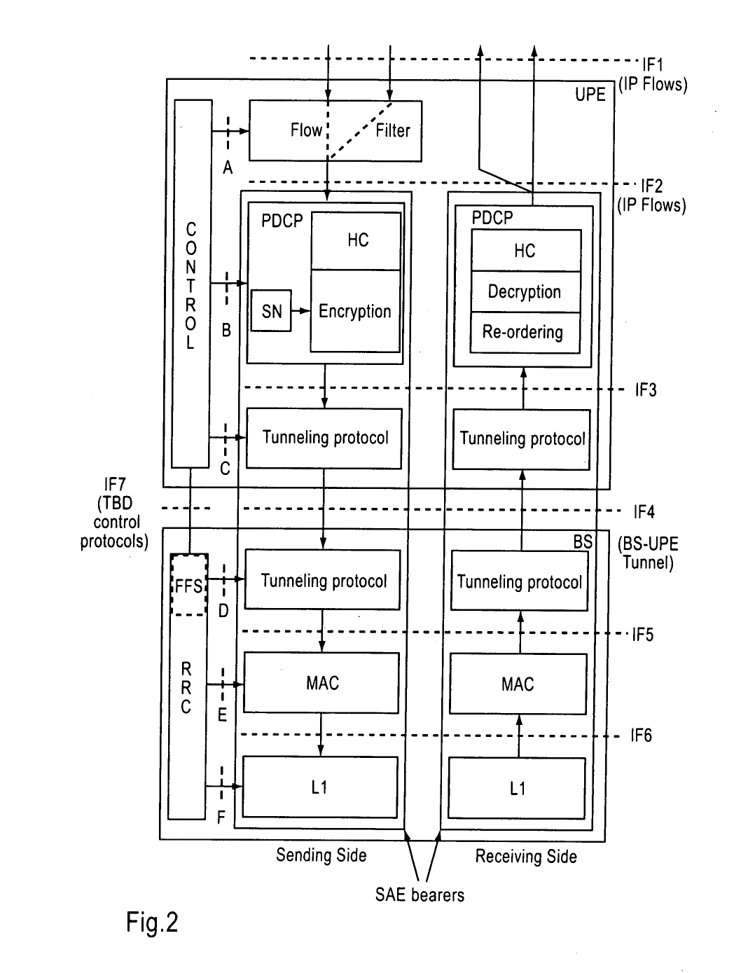

FIG. 2 illustrates LTE/SAE protocols showing that the header compression and ciphering functions are performed by a PDCP (packet data convergence protocol) protocol and are located in the UPE entity. The PDCP protocol shall not support re-transmissions of user data between the UE and the UPE.

The intra LTE handover shall apply temporary downlink user data forwarding between the eNBs (over an X2 interface (interface between two eNBs) using the GTP-U protocol) in order to provide lossless handovers on user plane.

The temporary forwarding from the eNB to the 2G or 3G target network in case of I-RAT handovers could be considered a natural solution. However, this becomes complex as the user downlink packets in the eNB are PDCP PDUs that are ciphered and possibly IP (internet protocol) header compressed. Now the eNB in the source network and the RNC or the 2G SGSN in the target network are not capable to decrypt and to de-compress these packets, so that these should be sent back to the UPE over S1-u for decrypting and de-compressing before forwarding to the target network.

In the following, lossless I-RAT handover solutions are described where temporary forwarding can be done directly from the UPE level or in the reverse direction from the RNC, I-HSPA or 2G SGSN level so that a duplicate packet delivery in the target network can be avoided.

1. LTE to UTRAN I-RAT Handover:

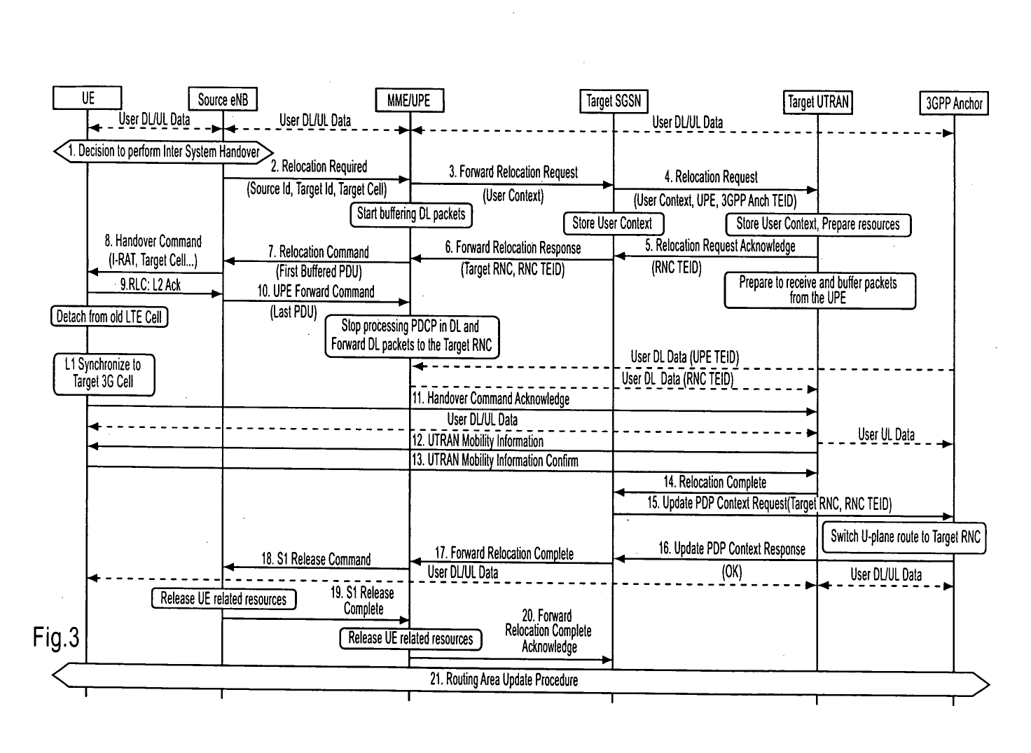

FIG. 3 shows a signalling flow during a lossless/seamless I-RAT handover from a LTE network to a UTRAN.

Initially, the user plane data flow over the S5-u interface (3GPP Anchor—UPE), the S1-u interface (UPE—eNB) and over the LTE radio link (eNB—UE) both in uplink and downlink directions.

Now, the following steps for a lossless/seamless LTE to UTRAN I-RAT handover are carried out wherein the numbering of the steps corresponds to that shown in FIG. 3:

1. A Source eNB is capable to make an I-RAT handover decision to a UTRAN cell based on received UE measurement data and configuration data about neighboring UTRAN cells.
2. The Source eNB sends a Relocation Request message to the MME/UPE indicating the target network and cell in order to initiate handover preparation.
3. The MME/UPE sends a Forward Relocation Request message with all the required user context data to the Target SGSN and start buffering user downlink datagrams received over the S5 interface. The buffered downlink data comprise S5 datagrams (full unaltered IP packets encapsulated into the GTP-U tunneling protocol). The UPE may still continue user downlink data ciphering and IP header compression at the PDCP protocol layer towards the S1-u interface at the same time.
4. The Target SGSN sends a Relocation Request message to the Target UTRAN (RNC or I-HSPA node) with the required user context data, UPE identifier and 3GPP Anchor TEID value for user uplink data.
5. The Target UTRAN stores user related data, prepares the required resources and send a Relocation Request Acknowledge message to the Target SGSN containing the RNC TEID (tunnel end point identifier) for user downlink data. From now on, the Target UTRAN is prepared to receive and buffer the forwarded user downlink datagrams over a temporary tunnel between the MME/UPE and the UTRAN.
6. The Target SGSN sends a Forward Relocation Response message to the MME/UPE with a Target RNC identifier and RNC TEID for user downlink data.
7. The MME/UPE sends a Relocation Command message to the Source eNB that indicates a successful I-RAT preparation in the target network and contains the number of the first buffered user downlink PDU.
8. The Source eNB checks whether or not its downlink buffer contains undelivered packets with an older sequence number than the first buffered downlink PDU in the UPE. In case such downlink PDUs are found, the eNB delivers these PDUs over the radio link before it sends a Handover Command message to the UE indicating an I-RAT handover to the Target Cell in the UTRAN. In this way, the loss of packets older than the first buffered packet in the UPE or delivery of those back to the UPE over SI-u can be avoided.
9. The UE responds with a L2 (layer 2) Ack (acknowledgement) message to the eNB indicating that it shall detach from the LTE radio link. Now the eNB is supposed to retrieve the number of the last delivered downlink PDU number over the radio (connection).
10. The eNB sends a UPE Forward Command to the MME/UPE indicating the last delivered user downlink PDU number. Upon reception of this message the UPE immediately stops the processing of the PDCP in downlink direction and starts forwarding the buffered user downlink packets to the target UTRAN beginning from the next undelivered user downlink datagram.
11. When the UE has performed a Li (layer 1) synchronization to the Target Cell in the UTRAN, it sends a Handover Command Acknowledge message to the Target UTRAN. From now on, the Target UTRAN is capable to deliver the forwarded user downlink packets to the UE and also to receive user uplink packets and forward those up to the 3GPP Anchor as well.
12. The Target UTRAN sends a UTRAN Mobility Information message to the UE. This message is used to update UTRAN mobility related information or new C-RNTI (cell radio network temporary identity).
13. The UE responds with a UTRAN Mobility Information Confirm message to the Target UTRAN.
14. The Target UTRAN sends a Relocation Complete message to the Target SGSN indicating successful handover.
15. The Target SGSN sends an Update PDP Context Request message to the 3GPP Anchor with the Target RNC identifier and RNC TEID in order to switch the S5 data path to the Target UTRAN (“one tunnel” solution bypassing the SGSN).
16. The 3GPP Anchor responds with a PDP Context Response message to the Target SGSN indicating a data path updating. Now, the new user downlink packets shall be sent to the Target UTRAN.
17. The Target SGSN sends a Forward Relocation Complete message to the MME/UPE.
18. The MME/UPE sends a S1 Release Command message to the Source eNB in order to release UE related resources in the eNB.
19. The Source eNB responds with a S1 Release Complete message to the MME/UPE indicating the resource release.
20. Now, the MME/UPE is able to release all user related resources and sends a Forward Relocation Complete Acknowledge message to the target SGSN.
21. Finally the routing area update procedure is executed in the target network that completes the LTE to UTRAN I-RAT handover.

2. LTE to GERAN I-RAT Handover:

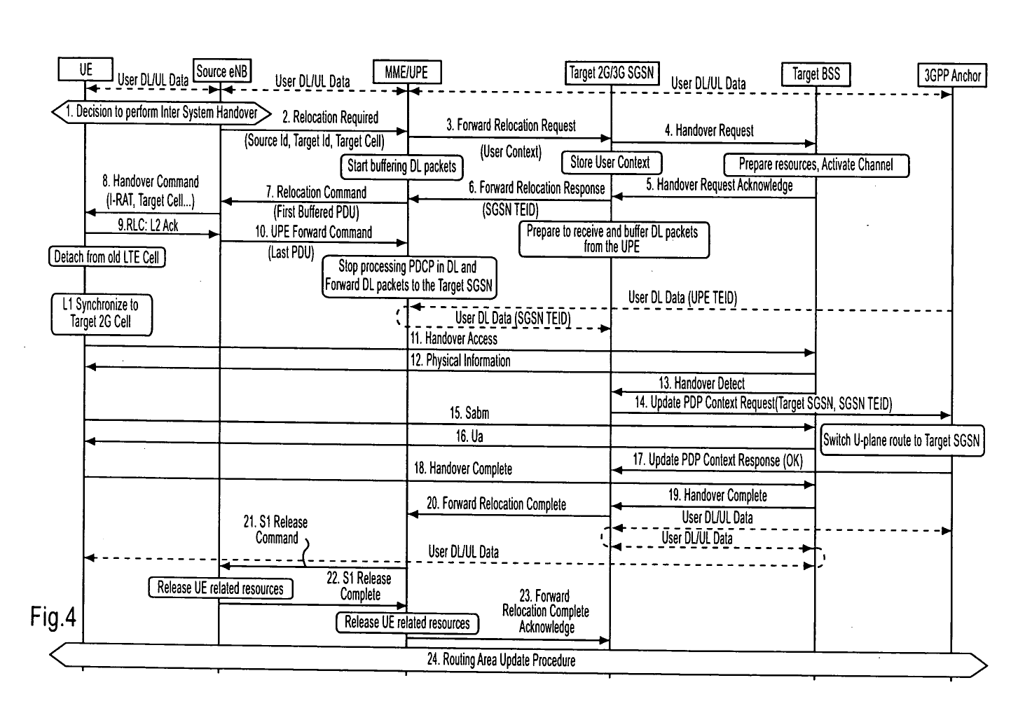

FIG. 4 shows a signalling flow during a lossless/seamless I-RAT handover from a LTE network to a GERAN using similar temporary forwarding principles as the above described I-RAT handover to the UTRAN.

Initially, the user plane data flow over the S5-u interface (3GPP Anchor—UPE), the S1-u interface (UPE—eNB) and over the LTE radio link (eNB—UE) both in uplink and downlink directions.

Now, the following steps for the lossless/seamless LTE to GERAN I-RAT handover are carried out wherein the numbering of the steps corresponds to that shown in FIG. 4:

1. A Source eNB is capable to make an I-RAT handover decision to a GERAN cell based on received UE measurement data and configuration data about neighboring GERAN cells.
2. The Source eNB sends a Relocation Request message to the MME/UPE indicating the target network and cell in order to initiate handover preparation.
3. The MME/UPE sends a Forward Relocation Request message with all the required user context data to the Target 2G/3G SGSN and start buffering user downlink datagrams received over the S5 interface. The buffered downlink data comprise S5 datagrams (full unaltered IP packets encapsulated into the GTP-U tunneling protocol). The UPE may still continue user downlink data ciphering and IP header compression at the PDCP protocol layer towards the S1-u interface at the same time.
4. The Target 2G/3G SGSN sends a Handover Request message to a Target BSS (base station subsystem) (BSC (base station controller)) with the required user context data.
5. The Target BSS stores user related data, prepares the required resources and send a Handover Request Acknowledge message to the Target 2G/3G SGSN. From now on, the Target 2G/3G SGSN is prepared to receive and buffer the forwarded user downlink datagrams over a temporary tunnel from the MME/UPE.
4. The Target SGSN sends a Forward Relocation Response message to the MME/UPE with a SGSN TEID for user downlink data.
5. The MME/UPE sends a Relocation Command message to the Source eNB that indicates a successful I-RAT preparation in the target network and contains the number of the first buffered user downlink PDU.
6. The Source eNB checks whether or not its downlink buffer contains undelivered packets with an older sequence number than the first buffered downlink PDU in the UPE. In case such downlink PDUs are found, the eNB delivers these PDUs over the radio link before it sends a Handover Command message to the UE indicating an I-RAT handover to the Target Cell in the UTRAN. In this way, the loss of packets older than the first buffered packet in the UPE or delivery of those back to the UPE over SI-u can be avoided.
7. The UE responds with a L2 Ack message to the eNB indicating that it shall detach from the LTE radio link. Now the eNB is supposed to retrieve the number of the last delivered downlink PDU number over the radio link.
8. The eNB sends a UPE Forward Command to the MME/UPE indicating the last delivered user downlink PDU number. Upon reception of this message, the UPE immediately stops the processing of the PDCP in downlink direction and starts forwarding the buffered user downlink packets to the target 2G/3G SGSN beginning from the next undelivered user downlink datagram.
9. When the UE (MS (mobile station)) has performed a L1 synchronization to the Target 2G Cell in the GERAN, it sends a Handover Access message to the Target BSS.
10. The Target BSS sends a Physical Information to the UE (MS) in order to configure L1 parameters in the radio network.
11. The Target BSS sends a Handover Detect message to the Target 2G/3G SGSN.
12. The Target BSS may send an Update PDP Context Request message to the 3GPP Anchor with a SGSN TEID in order to switch the S5 data path to the Target SGSN. An alternative way for sending this message is to make it after reception of a Handover Complete message (cf. step 19).
13. The UE (MS) sends a Sabm (set asynchronous balanced mode) message to the Target BSS.
14. The Target BSS responds with a Ua message to the UE (MS) (this massage procedure in 2G is meant for a LLC(logical link control)/SNDCP(subnetwork dependent convergence protocol) XID (exchange identification) negotiation between a 2G SGSN and a MS (UE)).
15. The 3GPP Anchor responds with a PDP Context Response message to the Target 2G/3G SGSN indicating a data path updating. Now, the new user downlink packets shall be sent to the Target
16. The UE (MS) sends a Handover Complete message to the Target BSS. Now, the user data path is established in the Target BSS.
17. The Target BSS sends a Handover Complete message to the Target 2G/3G SGSN. From now on, the Target 2G/3G SGSN is capable to deliver the forwarded user downlink packets to the UE (MS) and also to receive user uplink packets from the Target BSS and forward those up to the 3GPP Anchor as well. After delivering first the forwarded user downlink packets, the 2G/3G SGSN continues delivering the user downlink packets arriving from the 3GPP Anchor.
18. The Target 2G/3G SGSN sends a Forward Relocation Complete message to the MME/UPE.
19. The MME/UPE sends a SI Release Command message to the Source eNB in order to release UE related resources in the eNB.
20. The Source eNB responds with a SI Release Complete message to the MME/UPE indicating the resource release.
21. Now, the MME/UPE is able to release all user related resources and optionally may send a Forward Relocation Complete Acknowledge message to the target 2G/3G SGSN.
22. Finally, the routing area update procedure is executed in the target network that completes the LTE to GERAN I-RAT handover.

3. 3G to LTE/SAE I-RAT Handover:

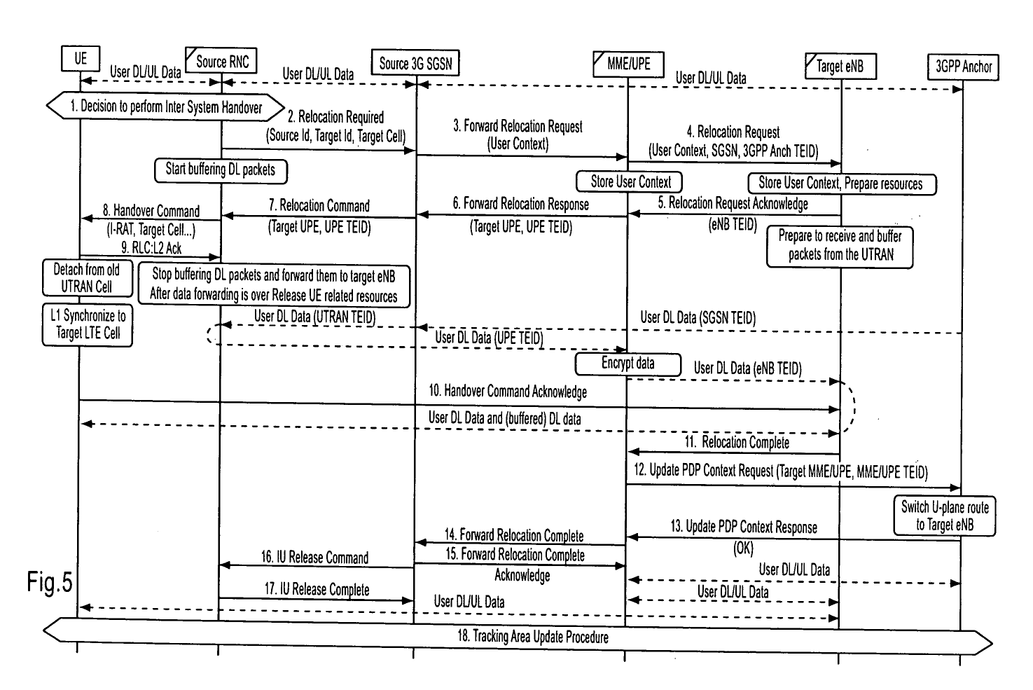

FIG. 5 shows a signalling flow during a lossless/seamless I-RAT handover from a 3G system to a LTE/SAE system.

Initially, the user plane data flow over an Iu-u interface (3GPP Anchor—RNC), an Iub interface (RNC—Node B) and over a UTRAN radio link (Node B—UE) both in uplink and downlink directions.

Now, the following steps for the lossless/seamless 3G to LTE/SAE I-RAT handover are carried out wherein the numbering of the steps corresponds to that shown in FIG. 5:

1. A Source RNC is capable to make an I-RAT handover decision to a LTE/SAE cell based on received UE measurement data and configuration data about neighboring LTE/SAE cells.
2. The Source RNC sends a Relocation Request message to a 3G SGSN indicating the target network and cell in order to initiate a handover preparation. The RNC starts buffering user downlink datagrams are received over the Iu-u interface. The buffered downlink data comprise IU-u datagrams (full unaltered IP packets encapsulated into a GTP tunneling protocol). It may still continue user downlink data ciphering and IP header compression at the PDCP protocol layer towards the Iub interface at the same time.
3. The 3G SGSN sends a Forward Relocation Request message with all the required user context data to the Target UPE/MME.
4. The Target MME/UPE sends a Relocation Request message to the Target eNB with the required user context data, RNC identifier and 3GPP Anchor TEID value for user uplink data.
5. The Target eNB stores user related data, prepares required resources and sends a Relocation Request Acknowledge message to the Target MME/UPE containing an eNB TEID for user downlink data. From now on, the Target MME/UPE is prepared to receive and buffer the forwarded user downlink datagrams over a temporary tunnel between the RNC and MME/UPE.
6. The Target MME/UPE sends a Forward Relocation Response message to the 3G SGSN with a Target MME/UPE identifier and MME/UPE TEID for user downlink data.
7. The 3G SGSN sends a Relocation Command message to the Source RNC that indicates a successful I-RAT preparation in the target network. It contains the Target MME/UPE identity and TEID.
8. The Source RNC calculates, based on signalling delay offset, a cell frequency number when the UE receives a Handover Command message indicating an I-RAT handover to the Target Cell in the LTE/SAE. At the same time it keeps track about downlink PDUs sent via the eNB to the UE.
9. The UE responds with a L2 ACK message to the RNC indicating that it shall detach from the 3G radio. Now the RNC is supposed to retrieve the number of the last delivered downlink PDU number. Via this way, it can be avoided the lost of downlink packets during the handover.
Upon reception of this message, the RNC immediately stops processing the PDCP in downlink direction and starts forwarding the buffered user downlink packets to the target UPE/MME beginning from the next undelivered user downlink datagram.
10. When the UE has performed a L1 synchronization to the Target Cell in the LTE/SAE, it sends a Handover Command Acknowledge message to the Target eNB which indicates that the UE has moved to the LTE/SAE successfully.
11. The Target eNB sends a Relocation Complete message to the UPE/MME. From now on, the Target UPE/MME is capable to deliver forwarded user downlink packets via the eNB to the UE and also to receive user uplink packets and forward those up to the 3GPP Anchor as well.
12. The Target MME/UPE sends an Update PDP Context Request message to the 3GPP Anchor with the Target MME/UPE identifier and the MME/UPE TEID in order to switch the Iu-u data path to the Target MME/UPE (“one tunnel” solution bypassing the SGSN).
13. The 3GPP Anchor responds with a PDP Context Response message to the Target MME/UPE indicating data path updating. Now, the new user downlink packets are sent to the Target MME/UPE.
14. The Target MME/UPE sends a Forward Relocation Complete message to the 3G SGSN.
15. Now, the 3G SGSN is able to release all user related resources and sends a Forward Relocation Complete Acknowledge message to the target SGSN.
16. The 3G SGSN sends an IU Release Command message to a Source RAN in order to release UE related resources in the RNC and Node B.
17. The Source RNC responds with an IU Release Complete message to the 3G SGSN indicating the resource release.
18. Finally the tracking area update procedure is executed in the target network that completes the 3G to LTE/SAE I-RAT handover.

4. I-HSPA Node to LTE/SAE I-RAT Handover:

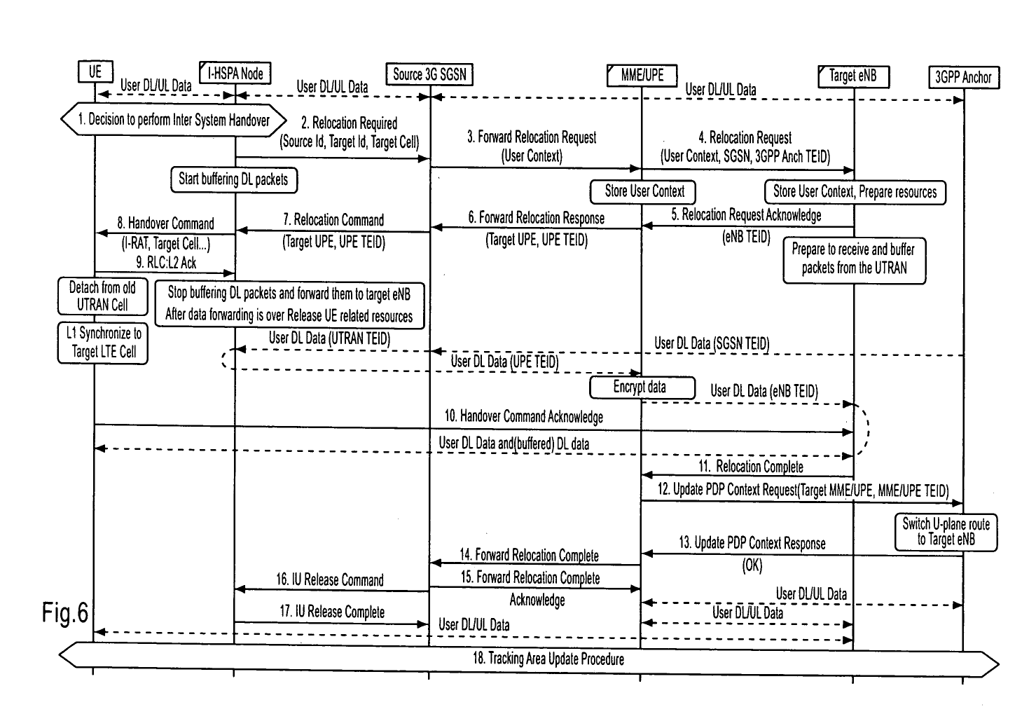

FIG. 6 shows a signalling flow during a lossless/seamless I-RAT handover between a I-HSPA Node and LTE/SAE using the same temporary forwarding principles as in the previous scenario (3G->LTE/SAE I-RAT handover).

It should be noted that in a 3G I-HSPA network a Source 3G SGSN is an optional network element if a GGSN has been implemented and deployed. In that case, the GGSN runs in the mode of the 3GPP Anchor. This brings a simplicity for the signalling.

Initially the user plane data flow over an Iu-u interface (3GPP Anchor—I-HSPA Node) and over an UTRAN radio link (I-HSPA Node—UE) both in uplink and downlink directions.

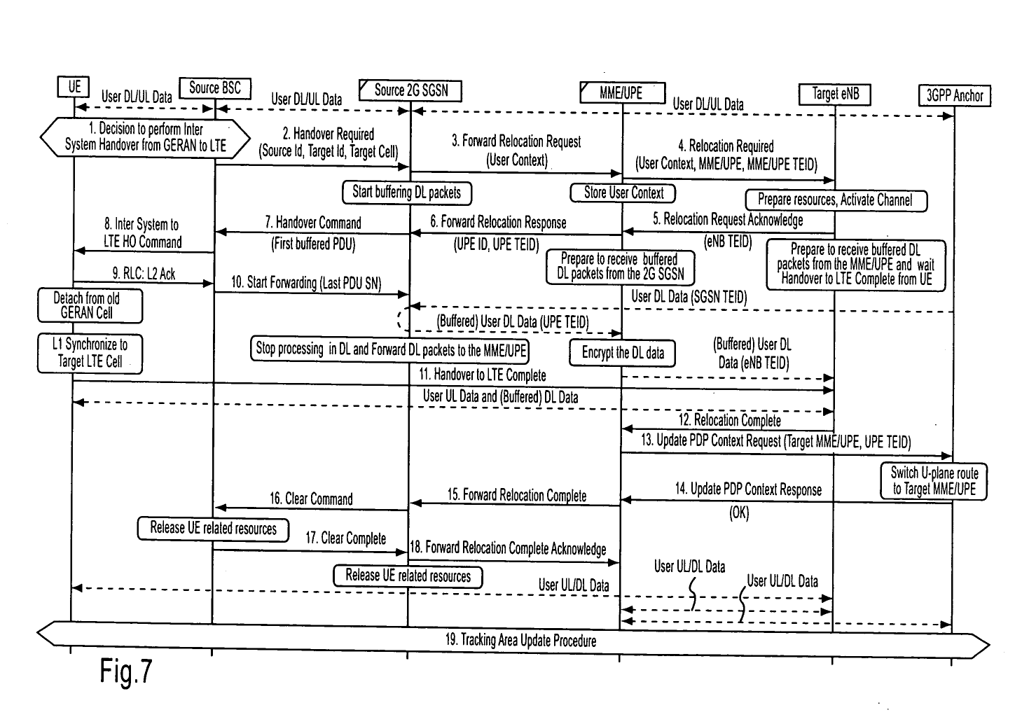

Now, the following steps for a lossless/seamless I-HSPA Node to LTE/SAE I-RAT handover are carried out wherein the numbering of the steps corresponds to that shown in FIG. 7:

1. A Source I-HSPA Node is capable to make an I-RAT handover decision to a LTE/SAE cell based on received UE measurement data and configuration data about the neighboring LTE/SAE cells.
2. The Source I-HSPA Node sends a Relocation Request message to a 3G SGSN indicating the target network and cell in order to initiate handover preparation. The I-HSPA Node starts buffering user downlink datagrams received over the Iu-u interface. The buffered downlink data comprise Iu-u datagrams (full unaltered IP packets encapsulated into a GTP tunneling protocol). It may still continue user downlink data ciphering and IP Header compression at a PDCP protocol layer towards the Iub interface at the same time.
3. The 3G SGSN sends a Forward Relocation Request message with all the required user context data to a Target UPE/MME.
4. The Target MME/UPE sends a Relocation Request message to a Target eNB with a required user context data, I-HSPA Node identifier and 3GPP Anchor TEID value for user uplink data.
5. The Target eNB stores user related data, prepares the required resources and sends a Relocation Request Acknowledge message to the Target MME/UPE containing an eNB TEID for user downlink data. From now on, the Target MME/UPE is prepared to receive and buffer the forwarded user downlink datagrams over a temporary tunnel between the I-HSPA Node and the MME/UPE.
6. The Target MME/UPE sends a Forward Relocation Response message to the 3G SGSN with a Target MME/UPE identifier and MME/UPE TEID for user downlink data.
7. The 3G SGSN sends a Relocation Command message to the Source I-HSPA Node that indicates a successful I-RAT preparation in the target network. It contains the Target MME/UPE identity and TEID.
8. The Source I-HSPA Node calculates, based on signalling delay offset, cell frequency number when the UE receives a Handover Command message indicating an I-RAT handover to the Target Cell in the LTE/SAE. At the same time it keeps track about downlink PDUs sent to the UE.
9. The UE responds with a L2 ACK message to the I-HSPA Node indicating that it shall detach from the 3G radio. Now, the I-HSPA Node is supposed to retrieve the number of the last delivered downlink PDU number. Via this way, it can be avoided the lost of downlink packets during the handover.
Upon reception of this message, the I-HSPA Node immediately stops processing the PDCP in downlink direction and starts forwarding the buffered user downlink packets to the target UPE/MME beginning from the next undelivered user downlink datagram.
10. When the UE has performed a L1 synchronization to the Target Cell in the LTE/SAE, it sends a Handover Command Acknowledge message to the Target eNB which indicates that the UE has moved to the LTE/SAE successfully.
11. A Target eNB sends a Relocation Complete message to the UPE/MME. From now on, the Target UPE/MME is capable to deliver forwarded user downlink packets via the eNB to the UE and also to receive user uplink packets and forward those up to the 3GPP Anchor as well.
12. The Target MME/UPE sends an Update PDP Context Request message to the 3GPP Anchor with Target the MME/UPE identifier and MME/UPE TEID in order to switch the Iu-u data path to the Target MME/UPE (“one tunnel” solution bypassing the SGSN).
13. The 3GPP Anchor responds with a PDP Context Response message to the Target MME/UPE indicating data path updating. Now, the new user downlink packets shall be sent to the Target MME/UPE.
14. The Target MME/UPE sends a Forward Relocation Complete message to the 3G SGSN.
15. Now, the 3G SGSN is able to release all user related resources and sends a Forward Relocation Complete Acknowledge message to the target SGSN.
16. The 3G SGSN sends an IU Release Command message to a Source RAN in order to release UE related resources in the I-HSPA Node.
17. The Source I-HSPA Node responds with an IU Release Complete message to the 3G SGSN indicating the resource release.
18. Finally the tracking area update procedure is executed in the target network that completes the 3G to LTE/SAE I-RAT handover.

5. GERAN to LTE/SAE I-RAT Handover

FIG. 7 shows a signalling flow during a lossless/seamless 2G to LTE/SAE I-RAT handover between a GERAN and LTE/SAE using similar temporary forwarding principles as in the previous scenario (I-HSPA→LETE/SAE I-RAT handover).

Initially the user plane data flow over a Gn interface (3GPP Anchor—2G SGSN), a Gb interface (2G SGSN—BSC), an Abis interface (base station controller BSC—base station transceiver system BTS) and a 2G radio (BTS—UE) both in uplink and downlink direction.

Now, the following steps for a lossless/seamless 2G to LTE/SAE I-RAT handover are carried out wherein the numbering of the steps corresponds to that shown in FIG. 7:

1. A Source BSC is capable to make an I-RAT handover decision to a LTE/SAE cell based on received UE (MS) measurement data and configuration data about neighboring LTE/SAE cells.
2. The Source BSC sends a Handover Request message to a 2G SGSN indicating the target network and cell in order to initiate a handover preparation.
3. The 2G SGSN sends a Forward Relocation Request message with all the required user context data to a Target MME/UPE and starts buffering user downlink datagrams received over the Gn interface. The buffered downlink data comprise Gn datagrams (full unaltered IP packets encapsulated into a GTP-U tunneling protocol). The 2G SGSN may still continue user downlink data ciphering and IP Header compression at a SNDCHP/LLC protocol layer towards the Gb interface at the same time.
4. The Target MME/UPE sends a Relocation Request message to a Target eNB with the required user context data, MME/UPE identifier and MME/UPE TEID value for user data.
5. The Target eNB stores user related data, prepares required resources and sends a Relocation Request Acknowledge message to the Target MME/UPE containing the eNB TEID for user downlink data. The message includes an Inter Network to LTE Handover Command message inside a transparent container. From now on, the Target eNB is prepared to receive and buffer the forwarded user downlink datagrams over a temporary tunnel between the MME/UPE and the eNB.
6. The Target MME/UPE sends a Forward Relocation Response message to the 2G SGSN with a Target MME/UPE identifier and MME/UPE TEID for user downlink data. The Target MME/UPE is now prepared to receive and buffer the forwarded user downlink datagrams over a temporary tunnel between the MME/UPE and the 2G SGSN.
7. The 2G SGSN sends a Handover Command message to the Source BSC that indicates a successful I-RAT preparation in the target network and contains the number of the first buffered user downlink PDU.
8. The Source BSC checks if its downlink buffer contains undelivered packets with an older sequence number than the first buffered downlink PDU in the 2G SGSN. In case such downlink PDUs are found, the BSC delivers these PDUs over the radio link, before it sends an Inter Network to LTE Handover Command message to the UE (MS) indicating an I-RAT handover to the Target Cell in the LTE/SAE. In this way, a loss of older packets than the first buffered packet in the 2G SGSN or a delivery of those back to the 2G SGSN over a Gb interface can be avoided.
9. The UE (MS) responds with a L2 ACK message to the BSC indicating that it shall detach from the 2G radio. Now, the BSC is supposed to retrieve the number of the last delivered downlink PDU number over the radio and Abis interfaces.
10. The BSC sends a Start Forwarding message to the 2G SGSN indicating the last delivered user downlink PDU number. Upon reception of this message, the 2G SGSN immediately stops processing the SNDCHP/LLC in downlink direction and starts forwarding the buffered user downlink packets to the target MME/UPE beginning from the next undelivered user downlink datagram.
11. When the UE has performed a L1 synchronization to the Target Cell in the LTE/SAE, it sends a Handover to LTE Complete message to the Target eNB. From now on the Target eNB is capable to deliver forwarded user downlink packets to the UE (MS) and also to receive user uplink packets and forward those up to the MME/UPE as well.
12. The Target eNB sends a Relocation Complete message to the Target MME/UPE indicating a successful handover. From now on, the Target MME/UPE is capable to deliver the forwarded user downlink packets via the eNB to the UE (MS) and also to receive user uplink packets and forward those up to the 3GPP Anchor as well.
13. The Target MME/UPE sends an Update PDP Context Request message to the 3GPP Anchor with the Target MME/UPE identifier and MME/UPE TEID in order to switch the Gn data path to the Target MME/UPE (“one tunnel” solution bypassing the 2G SGSN).
14. The 3GPP Anchor responds with a PDP Context Response message to the Target MME/UPE indicating data path updating. Now, the new user downlink packets are sent to the Target MME/UPE.
15. The Target MME/UPE sends a Forward Relocation Complete message to the 2G SGSN.
16. The 2G SGSN sends a Clear Command message to the Source BSC in order to release UE (MS) related resources in the BSS.
17. The Source BSC responds with a Clear Complete message to the 2G SGSN indicating the resource release.
18. Now, the 2G SGSN is able to release all user related resources and sends a Forward Relocation Complete Acknowledge message to the target MME/UPE.
19. Finally, the tracking area update procedure is executed in the target network that completes the 2G to LTE/SAE I-RAT handover.

Finally, it should be noted that the above preferred descriptions are of preferred examples for implementing the present invention, but the scope of the present invention should not necessarily be limited by this description. The scope of the present invention is defined by the following claims.

1. A method to perform a handover of a mobile equipment from a source network to a target network in a mobile telecommunication system, the method comprising:
data;
buffering data which may be transferred via the source network to the mobile equipment when the mobile equipment is linked to the source network, in a network element when a need for a handover arises; and
forwarding the data buffered in the network element from the network element to the target network for transferring the data to the mobile equipment after the mobile equipment has been linked to the target network.

2. The method according to claim 1, wherein the network element starts buffering only the data that cannot be transferred to the mobile equipment via the source network anymore after the mobile equipment has detached from the source network.

3. The method according to claim 1, further comprising:
buffering the received data at the target network until the mobile equipment is linked to the target network.

4. The method according to claim 3, further comprising:
buffering the received data at a node in the target network.

5. The method according to claim 1, further comprising:
terminating the buffering of the data by the network element after the mobile equipment has been linked to the target network.

6. The method according to claim 1, further comprising:
receiving further new data by the target network in addition to the data buffered in the network element.

7. The method according to claim 6, further comprising:
forwarding the further new data to the target network after the data buffered in the network element have been forwarded to the target network.

8. The method according to claim 1, further comprising:
buffering the data to be transferred to the mobile equipment in the source network; and
when older undelivered data are still buffered in the source network, postponing the handover until the older data buffered in the source network are transferred to the mobile equipment still linked to the source network.

9. The method according to claim 8, further comprising:
buffering the data at a node in the source network.

10. The method according to claim 1, wherein the data are downlink user data.

11. The method according to claim 1, wherein the source network is a network of a first kind and the target network is a network of a second kind.

12. The method according to claim 11, wherein the source network is a LTE (long term evolution) network and the target network is a 2G (second generation) network.

13. The method according to claim 11, wherein the source network is a LTE network and the target network is a 3G (third generation) network.

14. The method according to claim 11, wherein the source network is a 3G network and the target network is a (long term evolution) LTE network.

15. The method according to claim 11, wherein the source network is a 2G network and the target network is a (long term evolution) LTE network.

16. The method according to claims 11, wherein the source network is a HSPA (high speed, packet access) network and target network is a (long term evolution) LTE network.

17. A system to perform a handover of a mobile equipment from a source network to a target network in a mobile telecommunication system, comprising:
a network element comprising a buffer configured to buffer data for a handover, wherein the data may be transferred via the source network to the mobile equipment when the mobile equipment is linked to the source network; and
an interface operatively connected between the network element and the target network configured to forward the data buffered in the buffer of the network element from the network element to the target network to transfer the data to the mobile equipment after the mobile equipment has been linked to the target network.

18. The system according to claim 17, wherein the buffer of the network element starts buffering only the data that cannot be transferred to the mobile equipment via the source network anymore after the mobile equipment has detached from the source network.

19. The system according to claim 17, wherein the target network comprises a buffer configured to buffer the data received until the mobile equipment is linked to the target network.

20. The system according to claim 19, wherein a node in the target network comprises the buffer configured to buffer the received data to be transferred to the mobile equipment.

21. The system according to claim 17, wherein the buffer of the network element is configured to terminate the buffering of the data after the mobile equipment has been linked to the target network.

22. The system according to claim 17, wherein the target network comprises a receiver configured to receive further new data in addition to the data buffered in the buffer of the network element.

23. The system according to claim 22, wherein the receiver is configured to receive the further new data after the data buffered in the buffer of the network element have been received.

24. The system according to claim 17, wherein the source network comprises
a buffer configured to buffer the data to be transferred to the mobile equipment, and
a transmitter configured to transfer the data to the mobile equipment, wherein the network element is configured to postpone the handover in case older undelivered data are still buffered in the buffer of the source network until the transmitter of the source network has transferred the older data buffered in the buffer of the source network to the mobile equipment still linked to the source network.

25. The system according to claim 24, wherein a node in the source network comprises the buffer configured to buffer the data received from the network element.

26. The system according to claim 17, wherein the data are downlink user data.

27. The system according to claim 17, wherein the source network is a network of a first kind and the target network is a network of a second kind.

28. The system according to claim 27, wherein the source network is a LTE (long term evolution) network and the target network is a 2G (second generation) network.

29. The system according to claim 27, wherein the source network is a LTE (long term evolution) network and the target network is a 3G (third generation) network.

30. The system according to claim 27, wherein the source network is a 3G (third generation) network and the target network is a LTE (long term evolution) network.

31. The system according to claim 27, wherein the source network is a 2G (second generation) network and the target network is a LTE (long term evolution) network.

32. The system according to claims 27, wherein the source network is a HSPA (high speed packet access) network and target network is a LTE (long term evolution) network.

33. A network element to perform a handover of a mobile equipment from a source network to a target network in a mobile telecommunication system, comprising:
a buffer configured to buffer data for a handover, wherein the data may be transferred via the source network to the mobile equipment when the mobile equipment is linked to the source network; and
a transmitter configured to forward the data buffered in the buffer to the target network to transfer the data to the mobile equipment after the mobile equipment has been linked to the target network.

34. The network element according to claim 33, wherein the buffer starts buffering only the data that cannot be transferred to the mobile equipment via the source network anymore after the mobile equipment has detached from the source network.

35. The network element according to claim 33, wherein the buffer is configured to terminate the buffering of the data after the mobile equipment has been linked to the target network.

36. The network element according to claim 33, wherein the data are downlink user data.

37. The network element according to claim 33, wherein the source network is a network of a first kind and the target network is a network of a second kind.

38. The network element according to claim 37, wherein the source network is a LTE (long term evolution) network and the target network is a 2G (second generation) network.

39. The network element according to claim 37, wherein the source network is a LTE network and the target network is a 3G (third generation) network.

40. The network element according to claim 37, wherein the source network is a 3G network and the target network is a LTE (long term evolution) network.

41. The network element according to claim 37, wherein the source network is a 2G network and the target network is a LTE (long term evolution) network.

42. The network element according to claim 37, wherein the source network is a HSPA (high speed packet access) network and target network is a LTE (long term evolution) network.

43. A system for performing a handover of a mobile equipment from a source network to a target network in a mobile telecommunication system, comprising:
network element means comprising buffer means for buffering data for a handover, wherein the data may be transferred via the source network to the mobile equipment when the mobile equipment is linked to the source network; and
interface means operatively connected between the network element and the target network for forwarding the data buffered in the buffer of the network element from the network element to the target network for transferring the data to the mobile equipment after the mobile equipment has been linked to the target network.

44. A network element for performing a handover of a mobile equipment from a source network to a target network in a mobile telecommunication system, comprising:
buffer means for buffering data for a handover, wherein the data may be transferred via the source network to the mobile equipment when the mobile equipment is linked to the source network; and
transmitter means for forwarding the data buffered in the buffer to the target network for transferring the data to the mobile equipment after the mobile equipment has been linked to the target network.
